(19) United States
(12) Patent Application Publication
(10) Pub. No.: US 2008/0081226 A1
(43) Pub. Date: Apr. 3, 2008

(54) Structure and material of over-voltage protection device and manufacturing method thereof

(76) Inventors: Te-Pang Liu, Miaoli (TW); Hsiu-Yun Chang, Miaoli (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/598,782

(22) Filed: Nov. 14, 2006

(30) Foreign Application Priority Data
Sep. 28, 2006 (TW) 095136059

(51) Int. Cl. H01M 8/00

(52) U.S. Cl. 429/13

(57) ABSTRACT

The present invention relates to a material and structure of an over-voltage protection device. The material of the over-voltage protection device includes either a P-type semiconductor powder or an N-type semiconductor powder and an adhesive. The structure of the over-voltage protection device includes a first electrode, a second electrode, and a porous matrix connected between the first and second electrodes. The present invention further relates to a method of manufacturing the over-voltage protection device.

### FIELD OF THE INVENTION

The present invention relates to a material and structure of an electronic device, and more particularly to a material and structure of an over-voltage protection device and a manufacturing method thereof.

### BACKGROUND OF THE INVENTION

Over-voltage protection devices are widely used components in an electronic product for protecting some circuits in the electronic product from being damaged by sudden incoming charges. Generally, an over-voltage protection device is connected in parallel to both ends of the circuit to be protected, and an end of the over-voltage protection device is grounded. The over-voltage protection device is generally in a high impedance state. However, when abnormal charges (e.g., electrostatic charges) enter, the over-voltage protection device is changed transiently from the high impedance state to a low impedance state, and generates a transient current to conduct the abnormal invading energy to the ground end. Thus, the circuit is effectively protected from being damaged by electrostatic charges.

Common over-voltage protection devices include Schottky diodes. A high-cost semiconductor process is required when manufacturing diodes. Firstly, single crystals of Si or SiC must be fabricated, and then cut into wafers. Next, trivalent or pentavalent atoms are implanted into the wafer by means of doping, so as to form a P-type or N-type semiconductor layer. Then, pentavalent or trivalent atoms are implanted into the layer to form a body of a P—N diode. Finally, the wafer is cut into dies, and then, wires are connected to both P—N ends, and a packaging process is conducted, such that a diode device is formed. As the diode is a unidirectionally conductive element, when it is applied in the over-voltage protection of circuits, two diodes are required to guarantee the protection against both positive over-voltage and negative over-voltage. In addition, the protection device manufactured with the diode is a single crystal bulk, which causes a capacitance of 1 μF or above, and influences the property of circuits around.

In addition to Schottky diodes, U.S. Pat. No. 4,726,991 discloses a material of an over-voltage protection device. The technical feature of this patent lies in that the surface of a conductor or a semiconductor is fully covered by an insulating layer, so as to adjust the breakdown voltage of the over-voltage protection device by controlling a thickness of the insulating layer. However, the thickness of the insulating layer according to the teaching of the above patent is less than hundreds of angstroms, so the structure made of such a material has some defects in actual applications. For example, as the thickness of the insulating layer only falls within hundreds of angstroms, the thickness is hard to control. When the insulting layer is too thin, a short-circuit of the device may occur; and when the insulating layer is slightly thicker, the breakdown voltage is increased.

### SUMMARY OF THE INVENTION

Accordingly, an object of the present invention is to provide a structure and a material of an over-voltage protection device capable of reducing the manufacturing cost, and a manufacturing method thereof.

Another object of the present invention is to provide a structure and a material of an over-voltage protection device capable of simplifying the manufacturing process, and a manufacturing method thereof.

Still another object of the present invention is to provide a structure and a material of an over-voltage protection device with a lower capacitance, and a manufacturing method thereof.

According to an embodiment of the present invention, a powder and an adhesive for an over-voltage protection device are provided, wherein the powder includes P-type semiconductor powder or N-type semiconductor powder.

According to another embodiment of the present invention, a method of manufacturing an over-voltage protection device is provided. The method comprises: mixing a predetermined proportion of P-type semiconductor powder or N-type semiconductor powder with the adhesive evenly to form a material paste; applying the material paste on the substrate; and performing a firing process on the substrate to form an over-voltage protection device.

According to still another embodiment of the present invention, a structure of an over-voltage protection device is provided. The structure comprises a first electrode, a second electrode, and a porous matrix connected between the first and second electrodes.

P-type and N-type semiconductor powders do not need to be purified, and they are easily obtained. Thus, the material cost is greatly reduced. Furthermore, the over-voltage protection device is not manufactured through the conventional semiconductor manufacturing process; thus, the manufacturing cost is greatly reduced as well. Moreover, since lots of pores are distributed all over the porous matrix of the over-voltage protection device in the present invention, and the k value of the air is extremely low, the over-voltage protection device of the present invention has quite a low capacitance.

### BRIEF DESCRIPTION OF THE DRAWING

To fully understand the features and objects of the present invention, the accompanying drawings and the description are provided below for reference, wherein:

FIG. 1 is an enlarged view of a porous matrix of the present invention.

FIG. 2 is a current-voltage curve diagram of an over-voltage protection element of the present invention.

FIGS. 3A and 3B are respectively a front view and a side view of the over-voltage protection device according to an embodiment of the present invention.

FIG. 4 is a current-voltage curve diagram of the over-voltage protection element of FIG. 3.

FIGS. 5A and 5B are respectively a front view and a side view of an over-voltage protection device according to another embodiment of the present invention.

FIG. 6 is a current-voltage curve diagram of the over-voltage protection element of FIG. 5.

### DETAILED DESCRIPTION OF THE INVENTION

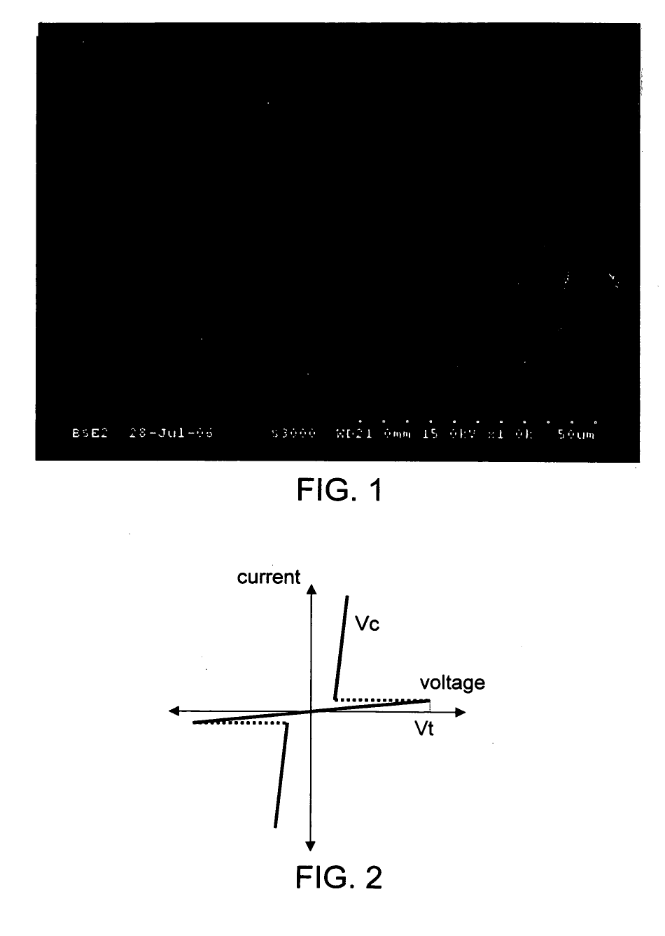

The present invention proposes a structure of a transient over-voltage protection device in an embodiment. The device includes a first electrode, a second electrode, and a porous matrix connected there between. FIG. 1 is an enlarged view of the porous matrix. In FIG. 1, the black part indicates pores. The size of the pores is approximately lower than 10 μm, and the black part takes 5%-90% of the total volume of the porous matrix.

According to an embodiment of the present invention, the material of the porous matrix includes semiconductor powder and an adhesive. Before the semiconductor powder is used to manufacture the over-voltage protection device, trivalent or pentavalent elements must be mixed into the semiconductor powder, such that the semiconductor powder has P-type or N-type characteristics. It should be noted that the present invention uses either the P-type or N-type semiconductor powders, instead of using both types of semiconductor powders. Then, a firing process is performed on the semiconductor powder and the adhesive that are formulated at a predetermined proportion and well blended. Thus, the porous matrix shown in FIG. 1 is obtained. It should be noted that the semiconductor powder used in this embodiment is a silicon-based semiconductor powder SiC, and the adhesive is a glass powder, a polymer resin solution, or a combination thereof. SiC is an artificial mineral, the SiC powder is generally formed by synthesizing silicon sand with coke, and nitrogen gas is required during the synthesis. Consequently, impurities often exist in the SiC powder. Generally, the purity of the synthesized SiC powder is 98%-99.99%. Thus, the synthesized SiC itself is semiconductive. Compared with the single crystal SiC applied in the semiconductor process with a purity up to 100% (i.e., an insulator), the silicon-based semiconductor powder applied in this embodiment is much cheaper, and is more easily obtained. It should be especially noted that the types of the semiconductor powder or the adhesive applied in the present invention are not limited to the aforementioned embodiment. Persons skilled in the art can easily use other materials with the same or similar characteristics to replace the above materials to fabricate the porous matrix.

In addition, the structural strength of the porous matrix, i.e., the adhesive force among the powder, is not generated by sintering, but generated by adhering with an appropriate amount of an appropriate adhesive. Moreover, as the formed porous structure has a stacked pore size naturally formed when powders accumulate, there are only physical contacts, without chemical bonding, in the powder except for the-positions where the adhesive is used for adhering. Therefore, the porous matrix formed according to the present invention has an extremely low capacitance. As long as an adhesive with appropriate characteristics is used, the amount of the adhesive is adjusted properly to prevent the adhesive from covering all the surface of the porous matrix. In other words, since there are only physical contacts, without chemical bonding, in the powder except for the positions where the adhesive is used, although the powder itself is semiconductive, contact impedance is naturally generated in the powder. Therefore, the over-voltage protection device manufactured according to this embodiment maintains a leakage current lower than 1 μA under a certain working voltage, and thus achieves a characteristic similar to insulation.

FIG. 2 is a current-voltage curve diagram of the over-voltage protection device of the aforementioned embodiment. As shown in FIG. 2, when the cross voltage across the over-voltage protection device exceeds a breakdown voltage Vt, a transient current is generated, such that the over-voltage protection device is changed from a high impedance to a low impedance transiently, and maintains the cross voltage at a relatively low voltage value Vc, so as to protect the circuit. Moreover, according to the embodiment of the present invention, when over-voltage protection devices with different breakdown voltages are required, the porous matrix must be first fabricated differently. Several practicable methods are listed as follows: (1) changing the compactness of the pores by adjusting the proportion of the semiconductor powder to the adhesive; (2) using semiconductor powder with different grain sizes or shapes; (3) using adhesives with different characteristics, for example, glass powders with different transition temperatures or different high temperature fluidities, polymer resins with different fluidity, or a combination of glass powder and polymer resins at different relative proportions.

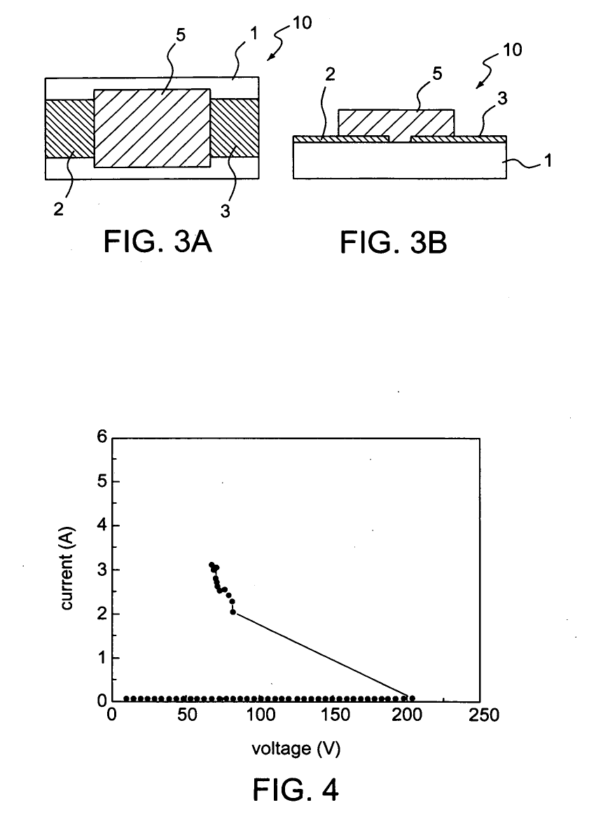

FIGS. 3A and 3B are respectively a front view and a side view of the over-voltage protection device 10 according to an embodiment of the present invention. The over-voltage protection device 10 includes a substrate 1, electrodes 2, 3, and a porous matrix 5. There is a gap 4 between the electrodes 2 and 3, and the porous matrix 5 is attached above the gap 4 and partially above the electrodes 2, 3.

The over-voltage protection device 10 of FIGS. 3A and 3B is manufactured through a thick-film molding process, and the manufacturing method includes the following steps: forming two electrodes 2, 3 on an aluminum oxide substrate 1; mixing a predetermined proportion of the semiconductor powder and the adhesive evenly, for example, in this embodiment, mixing 60 weight % of P-type or N-type SiC powder, 10 weight % of glass powder, and 30 weight % of ethyl cellulose resin solution with a 3-roll mill to form a material paste; then, printing the material paste above the electrodes 2, 3 and the gap there between; and finally, performing a “850° C. firing process on the material paste, such that the material paste is cured to form the porous matrix 5 attached to the aluminum oxide substrate 1. Under a working voltage of 12V, the leakage current of the over-voltage protection device 10 manufactured through the process described above is about 0.001 μA, and the capacitance is about 0.1 μF. FIG. 4 is a current-voltage current diagram of the over-voltage protection device 10 measured with a transmission line pulse (TLP) system.

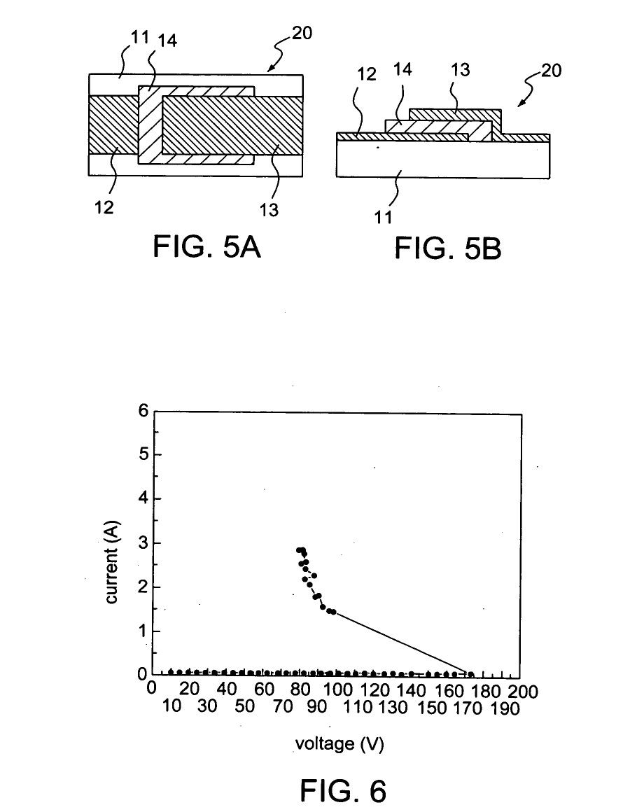

FIGS. 5A and 5B are respectively a front view and a side view of an over-voltage protection device 20 according to another embodiment of the present invention. The over-voltage protection device 20 includes a substrate 11, electrodes 12, 13, and a porous matrix 14. The porous matrix 14 is attached above the substrate 11 and the electrode 12, and the electrode 13 is attached above the substrate 11 and the porous matrix 14.

The method of manufacturing the over-voltage protection device 20 includes the following steps: forming an electrode 12 on an aluminum oxide substrate 11; forming a material paste according to the method described in the previous embodiment, and then, printing the material paste on the electrode 12; then, forming an electrode 13 to partially cover the printed material paste; and finally, curing the fired material paste to form the porous matrix 14 attached to the aluminum oxide substrate 11. Thus, the over-voltage protection device 20 is completely manufactured. Under the working voltage of 12V, the leakage current of the over-voltage protection device 20 manufactured according to the aforementioned embodiment is about 0.005 μA, and the capacitance is about 0.2 μF. FIG. 6 is a current-voltage current diagram of the over-voltage protection device 20 measured with a TLP system.

To sum up, the material of the over-voltage protection device in the present invention includes unpurified semiconductor powder that is easily obtained. Thus, the material cost is greatly reduced. The over-voltage protection device is not manufactured through the conventional semiconductor manufacturing process; Thus, the manufacturing cost is greatly reduced as well. Furthermore, the over-voltage protection device of the present invention has many pores, and the k value of the air is extremely low; thus, the over-voltage protection device has a capacitance lower than 1 μF. Moreover, the over-voltage protection device of the present invention can be manufactured through the thick-film process or the laminating process. Thus, it can be easily fabricated into a system on the chip.

The technical content and features of the present invention are disclosed above. Those skilled in the art can make modifications and variations without departing from the teaching and disclosure of the present invention. Therefore, the scope of protection of the present invention shall not be limited to what is disclosed by the embodiments, but shall include all other modifications and variations not departing from the present invention, given the modifications and variations covered by the following claims.

What is claimed is:

1. A material of an over-voltage protection device, comprising:
either a P-type semiconductor powder or a “N-type semiconductor powder; and
an adhesive.

2. The material of the over-voltage protection device as claimed in claim 1, wherein the P-type semiconductor powder or the N-type semiconductor powder is a silicon carbide powder with a purity of 98%-99.99%.

3. The material of the over-voltage protection device as claimed in claim 1, wherein a gain size of the P-type semiconductor powder or the N-type semiconductor powder is 1-50 μm.

4. The material of the over-voltage protection device as claimed in claim 1, wherein the adhesive includes a glass powder.

5. The material of the over-voltage protection device as claimed in claim 1, wherein the adhesive includes a polymer resin solution.

6. The material of the over-voltage protection device as claimed in claim 1, wherein the adhesive includes a glass powder and a polymer resin solution.

7. A method of manufacturing an over-voltage protection device, comprising:
evenly mixing a predetermined proportion of a P-type semiconductor powder or an N-type semiconductor powder with an adhesive to form a material paste;
applying the material paste on a substrate; and
performing a firing process on the substrate to form an over-voltage protection device.

8. The method as claimed in claim 7, wherein the step of applying the material paste on the substrate comprises:
forming a first electrode and a second electrode on the substrate; and
applying the material paste on the substrate, wherein the material paste partially overlaps the first and second electrodes.

9. The method as claimed in claim 7, wherein the step of applying the material paste on the substrate comprises:
forming a first electrode on the substrate;
printing the material paste on the substrate, wherein the material paste partially overlaps the first electrode; and
forming a second electrode on the substrate, wherein the second electrode partially overlaps the material paste.

10. A structure of an over-voltage protection device, comprising:
a first electrode;
a second electrode; and
a porous matrix, connected between the first electrode and the second electrode.

11. The structure as claimed in claim 10, wherein sizes of pores for the porous matrix are smaller than 10 μm.

12. The structure as claimed in claim 10, wherein the pores of the porous matrix take 5%-90% of the total volume of the structure.

13. The structure as claimed in claim 10, wherein the porous matrix is formed by performing a firing process on the material of the over-voltage protection device as claimed in claim 1.

14. The structure as claimed in claim 10, further comprising a substrate, wherein the first and second electrodes are both attached to the substrate and are spaced apart by a-gap, and the porous matrix is attached above the gap and partially above the first and second electrodes.

15. The structure as claimed in claim 10, further comprising a substrate, wherein the first electrode is attached to the substrate, the porous matrix is attached to the substrate and the first electrode, and the second electrode is attached above the substrate and the porous matrix.
